(19) United States
(12) Patent Application Publication
(10) Pub. No.: US 2020/0321609 A1
(43) Pub. Date: Oct. 8, 2020

(54) BATTERY

(71) Applicants: Umicore, Brussels (BE); Umicore Korea Ltd., Chungcheongnam-do (KR)

(72) Inventors: Stijn PUT, Olmen (BE); Daniël NELIS, Peer (BE); Jean-Sébastien BRIDEL, Cheonan (KR); Jeong-Rae KIM, Cheonan (KR)

(21) Appl. No.: 16/753,429

(22) PCT Filed: Sep. 12, 2018
(86) PCT No.: PCT/EP2018/074597

§ 371 Date: Apr. 3, 2020

(30) Foreign Application Priority Data
Oct. 16, 2017 (EP) 17196540.3

(51) Int. Cl. H01M 4/36; H01M 10/0525; H01M 4/38; H01M 10/0567; H01M 4/62; H01M 4/134; H01M 4/587

(52) U.S. Cl. CPC H01M 4/364; H01M 10/0525; H01M 4/386; H01M 10/0567; H01M 2004/027; H01M 4/62; H01M 4/134; H01M 4/587; H01M 4/366

(57) ABSTRACT

A lithium ion battery comprising a negative electrode and an electrolyte, whereby the negative electrode comprises composite particles, whereby the composite particles comprise silicon-based domains, whereby the composite particles comprise a matrix material in which the silicon-based domains are embedded, whereby the composite particles and the electrolyte have an interface, whereby at this interface there is a SEI layer, characterized in that the SEI layer comprises one or more compounds having carbon-carbon chemical bonds and the SEI layer comprises one or more compounds having carbon-oxygen chemical bonds, whereby a ratio, defined as the area of a first peak divided by the area of a second peak, is at least 1.30, whereby the first peak and second peak are peaks in an X-ray photoelectron spectroscopy measurement of the SEI, whereby the first peak represents C—C chemical bonds and whereby the second peak represents C—O chemical bonds.

The present invention relates to a lithium ion battery.

Lithium ion (Li-ion) batteries are currently the best performing batteries and already became the standard for portable electronic devices. In addition, these batteries already penetrated and rapidly gain ground in other industries such as automotive and electrical storage. Enabling advantages of such batteries are a high energy density combined with a good power performance.

A Li-ion battery typically contains a number of so-called Li-ion cells, which in turn contain a positive electrode, also called cathode, a negative electrode, also called anode, and a separator which are immersed in an electrolyte. The most frequently used Li-ion cells for portable applications are developed using electrochemically active materials such as lithium cobalt oxide or lithium nickel manganese cobalt oxide for the cathode and a natural or artificial graphite for the anode.

It is known that one of the important limitative factors influencing a battery's performance and in particular a battery's energy density is the active material in the anode. Therefore, to improve the energy density, newer electrochemically active materials based on silicon were investigated and developed during the last decades.

However, one drawback of using a silicon based electrochemically active material in an anode is its large volume expansion during charging, which is as high as 300% when the lithium ions are fully incorporated in the silicon based materials—a process often called lithiation. The large volume expansion of the silicon based materials during Li incorporation may induce stresses in the silicon, which in turn could lead to a mechanical degradation of the silicon based materials.

Repeated periodically during charging and discharging of the Li-ion battery, the repetitive mechanical degradation of the silicon based electrochemically active material may reduce the life of a battery to an unacceptable level.

In order to alleviate the deleterious effects of the volume change of the silicon based active material, a composite powder is often used for the negative electrode. Such a composite powder consists mostly of submicron or nanosized silicon based particles embedded in a matrix material, usually a carbon based material.

Further, the swelling of the silicon-based anode have a negative effect on the protective layer called SEI layer (Solid-Electrolyte Interface layer).

A SEI layer is a complex reaction product of the electrolyte and lithium. It mostly consists of polymer-like organic compounds and lithium carbonate.

The formation of a thick SEI layer or in other words the continuous decomposition of electrolyte is undesirable for two reasons: Firstly it consumes lithium and thereby leads to a loss of lithium availability for electrochemical reactions and therefore to a reduced cycle performance, which is the capacity loss per charging-discharging cycle. Secondly, a thick SEI layer may further increase the electrical resistance of a battery and thereby limit the achievable charging and discharging rates.

In theory, the SEI-layer formation is a self-terminating process that stops as soon as a ‘passivation layer’ has formed on the anode surface. However, because of the volume expansion of the composite powder the SEI may crack and or become detached during discharging (lithiation) and recharging (de-lithiation), thereby freeing new silicon surface and leading to a new onset of SEI formation.

In the art (for instance: US20070037063A1, US20160172665, and Kjell W. Schroder et al. Journal of Physical Chemistry C; vol. 11§, no 37, pages 19737-19747), the above lithiation/de-lithiation mechanism is generally quantified by or directly linked to a so-called coulombic efficiency, which is defined as a ratio (in % for a charge-discharge cycle) between the energy removed from a battery during discharge compared with the energy used during charging. Most work on silicon-based anode materials is therefore focused on improving said coulombic efficiency.

The accumulation of the deviation from 100% coulombic efficiency over many cycles determines a battery's usable life. Therefore, in simple terms, an anode having a coulombic efficiency of 99.9% is twice as good as an anode a having a coulombic efficiency of 99.8%.

In order to reduce the abovementioned and other problems, the invention concerns a lithium ion battery comprising a negative electrode and an electrolyte, whereby the negative electrode comprises composite particles, whereby the composite particles comprise silicon-based domains, whereby the composite particles comprise a matrix material, whereby the composite particles and the electrolyte have an interface, whereby at this interface there is a SEI layer, whereby the SEI layer comprises one or more compounds having carbon-carbon chemical bonds and the SEI layer comprises one or more compounds having carbon-oxygen chemical bonds, whereby a ratio, defined as the area of a first peak divided by the area of a second peak, is at least 1.30, whereby the first peak and second peak are peaks in an X-ray photoelectron spectroscopy measurement of the SEI, whereby the first peak represents C—C chemical bonds and is centered at 284.33 eV and whereby the second peak represents C—O chemical bonds and is centered at 285.83 eV.

Such a battery will have an improved cycle life performance compared to traditional batteries.

Preferably said ratio is at least 1.40. More preferably, said ratio is at least 1.50. Even more preferably said ratio is at least 1.60. Even more preferably said ratio is at least 1.80. Most preferably, said ratio is at least 2.0.

Without being bound by theory the inventors believe that this can be explained by the fact that compounds in the SEI-layer which are rich in C—C bonds are more polymer-like and lead to a more flexible and less brittle SEI-layer compared to compounds which are rich in C—O bonds, such as lithium carbonate.

As a consequence the SEI-layer is better able to withstand repeated expansion of the composite particles and is less susceptible to cracking, and will therefore give less rise to formation of new SEI layer material after each cycle.

A practical way of obtaining the desired ratio is by having certain elements present in the negative electrode. These elements will reduce the activation energy, and thereby increase the rate of reaction, of the reaction mechanisms in the SEI layer leading to high contents of polymer-like components.

Inevitable, a part these of these elements will end up in the SEI-layer itself.

Therefore, in a preferred embodiment said SEI layer contains one or more of these elements.

The previously mentioned elements are: Cr, Mo, W, Mn, Tc, Re, Fe, Ru, Os, Co, Rh, Ir, Ni, Pd, Pt, Zn Cd, Hg.

The mentioned elements are known for their catalytic effect on polymerisation reactions.

Preferably said previously mentioned elements are: Cr, Mo, W, Mn, Co, Fe, Ni, Zn, Cd, Hg, more preferably said previously mentioned elements are: Cr, Fe, Ni, Zn, and most preferably it is the element Ni.

In a preferred embodiment said electrolyte has a formulation comprising at least one organic carbonate, whereby preferably said at least one organic carbonate is fluoroethylene carbonate or vinylene carbonate or a mixture of fluoroethylene carbonate and vinylene carbonate.

A reduced consumption, or in other words an increased number of cycles until depletion, of said at least one organic carbonate is considered to be the key factor in determining the usable life of the battery.

In a further preferred embodiment said SEI layer comprises one or more reaction products of a chemical reaction of said at least one organic carbonate with lithium.

By a silicon-based domain is meant a cluster of mainly silicon having a discrete boundary with the matrix material. The silicon content in such a silicon-based domain is usually 80 weight % or more, and preferably 90 weight % or more.

In practice, such a silicon-based domain can be either a cluster of mainly silicon atoms or a discrete silicon particle in a matrix made from different material. A plurality of such silicon particles is a silicon powder.

In a preferred embodiment the silicon-based domains are silicon-based particles, meaning that they were, before forming the composite particles, individually identifiable particles that existed separately from the matrix material, since they were not formed together with the matrix.

Preferably the silicon-based domains have a weight based size distribution with a d₅₀ which is at most 150 nm and which is more preferably at most 120 nm.

The d₅₀ value is defined as the size of a silicon-based domain corresponding to 50 weight % cumulative undersize domain size distribution. In other words, if for example the silicon-based domain size d₅₀ is 93 nm, 50% of the total weight of domains in the tested sample are smaller than 93 nm.

Such a size distribution may be determined in a battery optically from SEM and/or TEM images by measuring at least 200 silicon-based domains. It should be noted that by domain is meant the smallest discrete domain that can be determined optically from SEM or TEM images. The size of a silicon based domain is then determined as the largest measurable line distance between two points on the periphery of the domain. Such an optical method will give a number-based domain size distribution, which can be readily converted to a weight based size distribution via well-known mathematical equations.

The silicon-based domains may have a thin surface layer of silicon oxide.

Preferably, the oxygen content of the silicon based domains is at most 10% by weight, more preferably at most 5% by weight.

Preferably, the silicon-based domains contain less than 10 weight % of elements other than Si and O, whereby more preferably the silicon-based domains contain less than 1 weight % of elements other than Si and O.

Even though the silicon-based domains are usually substantially spherical, they may have any shape, such as whiskers, rods, plates, fibers, etc.

In a preferred embodiment the matrix material is carbon.

In a preferred embodiment the matrix material comprises, or preferably consists of, thermally decomposed pitch.

In an embodiment the composite particles contain between 5 weight % and 80 weight % of Si, and in a narrower embodiment the composite particles contain between 10 weight % and 70 weight % of Si.

Preferably said composite particles, further also called first composite particles, are combined into second composite particles, whereby the second composite particles comprise one or more first composite particles and graphite.

Preferably the graphite is not embedded in the matrix material.

Preferably both the first composite particles as well as the second composite particles have a weight based particle size distribution having a d50 value which is at most 30 μm, and more preferably having a d90-value which is at most 50 μm.

The battery can be a fresh battery which is ready to be supplied to customers. Such a battery will already have undergone some limited electrochemical cycling as preparation for use, by or on behalf of the battery manufacturer, also called pre-cycling or conditioning. The battery can also be a used battery that has undergone electrochemical cycles as a consequence of having been in use.

The invention therefore relates to a process of cycling the battery according to the invention wherein electrochemical cycles are applied to said battery.

The invention will be further explained by the following counterexample and examples.

### Analytical Methods Used

### Determination of Oxygen Content

The oxygen contents were determined by the following method, using a Leco TC600 oxygen-nitrogen analyzer.

A sample of the product to be analyzed was put in a closed tin capsule that was put itself in a nickel basket. The basket was put in a graphite crucible and heated under helium as carrier gas to above 2000° C.

The sample thereby melts and oxygen reacts with the graphite from the crucible to CO or CO₂ gas. These gases are guided into an infrared measuring cell. The observed signal is recalculated to an oxygen content.

### Determination of the Silicon Particle Size Distribution of Nano Silicon Powders

0.5 g of Si powder and 99.50 g of demineralized water were mixed and dispersed by means of an ultrasound probe for 2 min @ 225 W.

The size distributions were determined on a Malvern Mastersizer 2000, using ultrasound during the measurement, using a refractive index for Si of 3.5 and an absorption coefficient of 0.1 and ensuring that the detection threshold was between 5 and 15%.

### Determination of Particle Size of Composite Powder

Particle size distributions for composite powders were determined in an analogous dry method on the same equipment.

The following measurement conditions were selected: compressed range; active beam length 2.4 mm; measurement range: 300 RF; 0.01 to 900 μm. The sample preparation and measurement were carried out in accordance with the manufacturer's instructions.

### Determination of Electrochemical Performance

Batteries to be evaluated were tested as follows:

The lithium full cell batteries are charged and discharged several times under the following conditions, at 25° C., to determine their charge-discharge cycle performance:
Charge is performed in CC mode under 1 C rate up to 4.2V, then CV mode until C/20 is reached,
The cell is then set to rest for 10 min,
Discharge is done in CC mode at 1 C rate down to 2.7V,
The cell is then set to rest for 10 min,
The charge-discharge cycles proceed until the battery reaches 80% retained capacity. Every 25 cycles, the discharge is done at 0.2 C rate in CC mode down to 2.7 V.

The retained capacity at the n^{th} cycle is calculated as the ratio of the discharge capacity obtained at cycle n to cycle 1.

Analogous experiments were also done at charge and discharge rates of C/5.

The number of cycles until the battery reaches 80% retained capacity is reported as the cycle life.

### Determination of Ratio of C—C Bonds to C—O Bonds by XPS Measurement

X-ray photoelectron spectroscopy (XPS) were performed on an PHI 5000 VersaProbe (Ulvac-PHI). The X-ray source was a Monochromator Al Ka(1486.6 eV) Anode (24.5 W, 15 kV)

Calibration was done the C1s peak at 284.6 eV.

The following conditions were used:

Spot size: 100 um×100 um; Wide scan pass energy: 117.4 eV; Narrow scan pass energy: 46.950 eV)

The measurement focused on the signal of carbon (between 295 eV and 280 eV)

Using XPSPEAK 4.1 peak deconvolution software the peak areas were determined of the peak at 284.33 eV, representing aliphatic C—C chemical bonds and the peak at 285.83 eV, representing C—O chemical bonds, and their ratio R1, were determined.

### EXAMPLE A, ACCORDING TO THE INVENTION

### Preparation of a First Composite Powder

A silicon nano powder was obtained by applying a 60 kW radio frequency (RF) inductively coupled plasma (ICP), using argon as plasma gas, to which a micron-sized silicon powder precursor was injected at a rate of circa 200 g/h, resulting in a temperature in the reaction zone above 2000K.

In this first process step the precursor became totally vaporized. In a second process step an argon flow was used as quench gas immediately downstream of the reaction zone in order to lower the temperature of the gas below 1600K, causing a nucleation into metallic submicron silicon powder.

Finally, a passivation step was performed at a temperature of 100° C. during 5 minutes by adding 1001/h of a N₂/O₂ mixture containing 1 mole % oxygen.

The gas flow rate for both the plasma and quench gas was adjusted to obtain nano silicon powder with an average particle diameter d₅₀ of 75 nm and a d₉₀ of 341 nm. In the present case 2.0 Nm³/h Ar was used for the plasma and 15 Nm³/h Ar was used as quench gas.

The oxygen content was measured at 2 w %

The purity of the nano silicon powder was tested and was found to be >99.8%, not taking oxygen into account.

A blend was made of 14.5 g of the mentioned silicon nano powder and 24 g petroleum based pitch powder.

This was heated to 450° C. under N₂, so that the pitch melted, and, after a waiting period of 60 minutes, mixed for 30 minutes under high shear by means of a Cowles dissolver-type mixer operating at 1000 rpm.

The mixture of silicon nano powder in pitch thus obtained was cooled under N₂ to room temperature and, once solidified, pulverized and sieved on a 400 mesh sieve, so produce a composite powder.

This composite powder was ball-milled at low intensity together with 0.1 wt % of nanosized nickel powder having an average particle size of circa 10 nm, so that the nano nickel powder became coated onto the mixture of silicon nano powder in pitch, producing a further composite powder made up of first composite particles. The nickel nanopowder was obtained from Aldrich (CAS Number 7440-02-0) and milled to decrease further the particles size.

EDS-SEM mapping confirmed that the nickel nano powder formed a more or less continuous layer on the surface of the first composite particles.

Alternatively, nickel could be coated around the composite by a similar method onto the pitch-silicon particles in the form of a nickel oxide or a nickel salt. Also, mixing of the pitch-silicon particles with a solution of a nickel salt followed by drying can lead to a coating layer rich in nickel. Atomic layer deposition can also be used to deposit a thinner but more homogeneous layer of Nickel.

8 g of the pulverized mixture was mixed with 7.1 g graphite for 3 hrs on a roller bench, after which the obtained mixture was passed through a mill to de-agglomerate it. At these conditions good mixing is obtained but the graphite doesn't become embedded in the pitch.

A thermal after-treatment was given to the obtained mixture of silicon, pitch and graphite as follows: the product was put in a quartz crucible in a tube furnace, heated up at a heating rate of 3° C./min to 1000° C. and kept at that temperature for two hours and then cooled. All this was performed under argon atmosphere.

The fired product was pulverized and sieved on a 400 mesh sieve to form a further composite powder made up of second composite particles, and is further designated composite powder A.

The total Si content in the composite powder A. was measured to be 23 wt %+/−0.5 wt % by chemical analysis. This corresponds to a calculated value based on a weight loss of the pitch upon heating of circa 40 wt % and an insignificant weight loss upon heating of the other components.

The oxygen content of composite powder A. was 1.7%

Composite powder A had a d50 of 14 μm and a d90 of 27 μm.

For completeness it is mentioned that a calculated value of the composition of the first composite particles after the mentioned thermal treatment was 50% Si and 50% carbon, being thermally decomposed pitch.

### Negative Electrode Preparation

A 2.4 wt % Na-CMC solution was prepared and dissolved overnight. Then, TIMCAL Carbon Super P, a conductive carbon was added to this solution and stirred for 20 minutes using a high-shear mixer.

A mixture of graphite and composite powder A was made. The ratio was calculated to obtain a theoretical negative electrode reversible capacity of 500 mAh/g dry material.

The mixture of graphite and composite powder A was added to the Na-CMC solution and the slurry was stirred again using a high-shear mixer during 30 minutes.

The slurry was prepared using 94 wt % of the mixture of graphite and composite powder A, 4 wt % of Na-CMC and 2 wt % of the conductive carbon.

A negative electrode was then prepared by coating the resulting slurry on a copper foil, at a loading of 6.25 mg dry material/cm² and then dried at 70° C. for 2 hours. The foil was coated on both sides and calenderer.

### Positive Electrode Preparation

A positive electrodes was prepared in a similar way as the negative electrode, except using PVDF dissolved in NMP based binder (PVDF) instead of Na-CMC in water and using a 15 μm thickness aluminium foil current collector instead of copper. The foil was coated on both sides and calendared.

Commercially available LiCoO₂ for battery applications was used as active material.

The loading of active materials on the negative electrode and on the positive electrode is calculated to obtain a capacity ratio of 1.1.

### Manufacture of Battery Cells for Electrochemical Testing.

Pouch type battery cells of 650 mAh were prepared, using a positive electrode having a width of 43 mm and a length of 450 mm. An aluminum plate serving as a positive electrode current collector tab was arc-welded to an end portion of the positive electrode. A nickel plate serving as a negative electrode current collector tab was arc-welded to an end portion of the negative electrode.

A sheet of the positive electrode, a sheet of the negative electrode, and a sheet of separator made of a 20 μm-thick microporous polymer film (Celgard® 2320) were spirally wound into a spirally-wound electrode assembly. The wound electrode assembly and the electrolyte were then put in an aluminum laminated pouch in an air-dry room, so that a flat pouch-type lithium battery was prepared having a design capacity of 650 mAh when charged to 4.20 V.

LiPF₆ 1M in a mixture of 10% fluoroethylene carbonate and 2% vinylene carbonate in a 50/50 mixture of ethylene carbonate and diethyl carbonate was used as electrolyte.

The electrolyte solution was allowed to impregnate for 8 hrs at room temperature. The battery was pre-charged at 15% of its theoretical capacity and aged 1 day, at room temperature. The battery was then degassed and the aluminum pouch was sealed.

The battery was prepared for testing as follows: under pressure, the battery was charged using a current of 0.2 C (with 1 C=650 mA) in CC mode (constant current) up to 4.2V then CV mode (constant voltage) until a cut-off current of C/20 was reached, before being discharged in CC mode at 0.5 C rate down to a cut-off voltage of 2.7V.

The battery is further called: battery A.

### Example B, not According to the Invention

The same procedure as for example A was followed, except that no nickel was added. In order to ensure maximum comparability between examples A and B, the ball milling step was nevertheless performed, but without nickel. Battery B was thus produced.

### Example C, According to the Invention

The same procedure as for example A was followed, except that 1.0 wt % of nickel was added instead of 0.1 wt %. Battery C was thus produced.

### Analysis

Electrochemical tests as outlined above were performed on batteries A and B and C. The results are in table 1.

TABLE 1

| | Number of cycle to | Number of cycle to |
|---|---|---|
| | reach 80% of initial | reach 80% of initial |
| Battery | capacity at 1 C current | capacity at C/5 current |
| A | 262 | 301 |
| B | 153 | 169 |
| C | 548 | 577 |

After the electrochemical tests, the negative electrodes were removed from batteries A and B and C.

In both cases a SEI-layer could be analyzed by XPS at the surface of the silicon-decomposed pitch particles, as a result of chemical reactions between lithium and the electrolyte, at this surface.

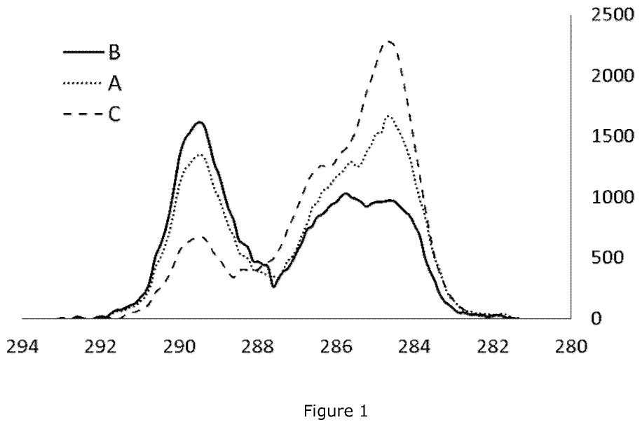

The data are represented graphically in FIG. 1, in which the horizontal axis represent the bonding energy in eV and the vertical axis represents the signal strength. The signal for the SEI layer of the negative electrode of battery A is represented by a finely dotted line, the signal for the SEI layer of the negative electrode of battery B is represented by solid line and the signal for the SEI layer of the negative electrode of battery C is represented by a coarsely dotted line

The signals were deconvoluted and analyzed in order to determine the ratio R1. This is reported in table 2.

TABLE 2

| SEI layer originating from battery . . . | R1 |
|---|---|
| A (according to the invention) | 1.64 |
| B (not according to the invention) | 1.21 |
| C (according to the invention) | 2.46 |

As can be seen it was found that the ratio R1 of C—C chemical bonds to C—O chemical bonds was highest in the SEI layer of the negative electrode of battery C, followed by the SEI layer of the negative electrode of battery A, and lowest in the SEI layer of the negative electrode of battery B.

SEM and TEM analysis, combined with EDX analysis, was performed on the negative electrodes. This confirmed that, for batteries A and C, by far most of the nickel was still present on the surface of the first composite particles.

1-15. (canceled)

16. A lithium ion battery comprising a negative electrode and an electrolyte,
wherein the negative electrode comprises composite particles, and the composite particles comprise silicon-based domains and a matrix material in which the silicon-based domains are embedded,
wherein the composite particles and the electrolyte have an interface, and
wherein at the interface, there is an SEI layer,
wherein the SEI layer comprises one or more compounds having carbon-carbon chemical bonds and one or more compounds having carbon-oxygen chemical bonds, and
wherein a ratio for the SEI layer, defined as the area of a first peak divided by the area of a second peak, is at least 1.30, wherein the first peak and second peak are peaks in an X-ray photoelectron spectroscopy measurement of the SEI layer, whereby the first peak represents C—C chemical bonds and is centered at 284.33 eV and whereby the second peak represents C—O chemical bonds and is centered at 285.83 eV.

17. A battery according to claim 16, wherein said ratio is at least 1.60.

18. A battery according to claim 16, wherein said electrolyte has a formulation comprising at least one organic carbonate.

19. A battery according to claim 18, wherein said at least one organic carbonate comprises fluoroethylene carbonate or vinylene carbonate or a mixture of fluoroethylene carbonate and vinylene carbonate.

20. A battery according to claim 18, wherein said SEI layer comprises one or more reaction products from a chemical reaction of said at least one organic carbonate with lithium.

21. A battery according to claim 16, wherein said negative electrode comprises one or more of the following elements: Cr, Mo, W, Mn, Tc, Re, Fe, Ru, Os, Co, Rh, Ir, Ni, Pd, Pt, Zn, Cd, or Hg.

22. A battery according to claim 16, wherein said negative electrode comprises one or more of the following elements: Cr, Mo, W, Mn, Co, Fe, Ni, Zn, Cd, Hg.

23. A battery according to claim 16, wherein said negative electrode comprises one or more of the following elements: Cr, Fe, Ni, Zn.

24. A battery according to claim 16, wherein said negative electrode comprises the element Ni.

25. A battery according to claim 16, wherein the silicon-based domains are silicon-based particles embedded in the matrix material.

26. A battery according to claim 16, wherein the silicon-based domains contain less than 10 weight % of elements other than Si and O.

27. A battery according to claim 16, wherein the matrix material is carbon.

28. A battery according to claim 16, wherein the matrix material comprises at least 50 wt % of pitch or thermally decomposed pitch.

29. A battery according to claim 16, wherein the silicon-based domains have a weight based size distribution having a d50 value which is at most 150 nm.

30. A process of cycling the battery according to claim 16, comprising applying electrochemical cycles to said battery.
